(19) United States
(12) Patent Application Publication
(10) Pub. No.: US 2015/0338847 A1
(43) Pub. Date: Nov. 26, 2015

(54) METHOD AND APPARATUS FOR DISCOVERING EQUIPMENT CAUSING PRODUCT DEFECT IN MANUFACTURING PROCESS

(71) Applicant: SAMSUNG ELECTRONICS CO., LTD., Suwon-si (KR)

(72) Inventors: Seung Hoon TONG, Suwon-si (KR); Jong Myoung KO, Hwaseong-si (KR); Chang Ouk KIM, Seoul (KR); Doowon CHOI, Seoul (KR); Hoyeop LEE, Seoul (KR)

(21) Appl. No.: 14/674,383

(22) Filed: Mar. 31, 2015

(30) Foreign Application Priority Data
May 20, 2014 (KR) 10-2014-0060603

(51) Int. Cl. G05B 19/418

(52) U.S. Cl. CPC G05B 19/41875; G05B 2219/32204

(57) ABSTRACT

A method for determining defect causing equipment in a manufacturing process includes collecting equipment sequence data and processing result data of a plurality of products, calculating defect contribution scores for a plurality of equipment based on the collected data, and applying a modified association rule to the equipment based on the calculated contributions scores. The modified association rule to generate rules reflecting a cumulative effect of an equipment sequence and equipment contributing to a defect of at least some of the products. The method also includes calculating a defect-introducing index based on the calculated contribution scores and the modified association rule, and identifying at least one of the plurality of equipment as causing the defect of the products based on the defect-introducing index.

### CROSS-REFERENCE TO RELATED APPLICATION

Korean Patent Application No. 10-2014-0060603, filed on May 20, 2014, and entitled, “Method and Apparatus For Discovering Equipment Causing Product Defect In Manufacturing Process,” is incorporated by reference herein in its entirety.

### BACKGROUND

1. Field

One or more embodiments described herein relate to a method and an apparatus for discovering equipment causing a product defect in a manufacturing process.

2. Description of the Related Art

Manufacturing yield is important for purposes of determining the cost and quality and cost of a product. Manufacturing yield may be a function of the type of equipment used and the processes to be performed by the equipment. For example, a process for forming fine patterns in a semiconductor manufacturing process may include many processes, and various types of processing equipment may be used according to a set schedule.

The equipment to be used may substantially increase, for example, in proportion to the number of processes to be performed. Consequently, it is difficult to determine which equipment may be responsible for causing a product defect.

In addition, an interrelationship among equipment for performing prior and subsequent processes may cause product defects. For example, a product defect may be caused by a cumulative effect of the prior and subsequent processes. The cumulative effect may be caused, for example, based on an interrelationship among the processing equipment, in addition to an interrelationship among the processes.

### SUMMARY

In accordance with one or more embodiments, a method for determining defect causing equipment in a manufacturing process, the method including collecting equipment sequence data and processing result data of a plurality of products; calculating defect contribution scores for a plurality of equipment based on the collected data; applying a modified association rule to the equipment based on the calculated contributions scores, the modified association rule to generate rules reflecting a cumulative effect of an equipment sequence and equipment contributing to a defect of at least some of the products; calculating a defect-introducing index based on the calculated contribution scores and the modified association rule; identifying at least one of the plurality of equipment as causing the defect of the products based on the defect-introducing index; and outputting information on a display indicative of at least one of the equipment causing the defect of the products.

Collecting the equipment sequence data and the processing result data of the products may include generating a binary representation of the equipment sequence data depending on whether or not corresponding ones of the plurality of equipment are involved in manufacture of the products; and generating a binary representation of the processing result data depending on whether or not the products are normal.

Calculating the contribution score may be performed based on a multi-variate regression analysis method or a variable selection method. The multi-variate regression analysis method or the variable selection method may be one of a partial least square regression-important in the projection (PLSR-VIP) method, a minimum-redundancy-maximum-relevance (mRMR) variable selection method, or a support vector machine recursive feature elimination (SVM-RFE) method.

Applying the modified association rule may include generating the rules by removing equipment having contribution scores equal to or less than a first reference value from equipment corresponding to the equipment sequence data; calculating cumulative effect values from the rules, the cumulative effect values generated by equipment of a subsequent process among equipment included in the rules; selecting rules having cumulative effect values greater than a second reference value; and calculating a representative value of parameters generated in applying the modified association rule, with respect to the selected association rules. The cumulative effect value may be a ratio of an amount of accuracy increased by the subsequent process to an accuracy of a former process.

Applying the modified association rule may be performed based on Apriori algorithm, Eclat algorithm, AprioriDP algorithm, or CMPNARM algorithm. The defect-introducing index may include a first function using at least one of the contribution score, the representative value, or a number of defect products as an independent variable. The representative value may be one of an arithmetic mean value, a robust mean value, a trimmed mean value, a weighted mean value, a geometric mean value, a harmonic mean value, or a median value.

The defect-introducing index may include a second function, and an independent variable of the second function may be a mean value of the number of equipment corresponding to the association rules having cumulative effect values greater than the second reference value.

In accordance with another embodiment, an apparatus for determining defect causing equipment includes an input to collect equipment sequence data and processing result data of a plurality of products; and a controller to calculate contribution scores for a plurality of equipment based on the collected data, to apply a modified association rule to the equipment based on the calculated contributions scores, the modified association rule generating rules reflecting a cumulative effect of an equipment sequence and equipment contributing to a defect in at least some of the products, and to calculate a defect-introducing index based on the calculated contribution scores and the modified association rule, the defect-introducing index corresponding to at least one of the plurality of equipment causing the defect, the controller to output information on a display indicative of at least one of the equipment causing the defect of the products.

The controller may generate a binary representation of the equipment sequence data depending on whether the equipment are involved in the manufacture of the products or not, and may generate a binary representation of the processing result data depending on whether or not the products are normal. The controller may calculate the contribution scores by one of a partial least square regression-important in the projection (PLSR-VIP) method, a minimum-redundancy-maximum-relevance (mRMR) variable selection method, or a support vector machine recursive feature elimination (SVM-RFE) method. The cumulative effect may be a ratio of an amount of accuracy increased by a subsequent process to an accuracy of a former process.

The controller may remove equipment having contribution scores equal to or less than a first reference value from equipment corresponding to the equipment sequence data to generate the rules, calculate cumulative effect values from the rules, the cumulative effect values are generated by an equipment of the subsequent process among equipment included in the association rules, select rules of which the cumulative effect values are greater than a second reference value, and calculate a representative value of parameters generated in applying the modified association rule, with respect to the selected rules.

In accordance with another embodiment, an apparatus includes a memory to store equipment sequence data and processing result data for manufacturing a plurality of products, at least some of the products having a defect; and a controller to calculate contribution scores for a plurality of equipment used to manufacture the products based on the collected data and to identify at least one of the plurality of equipment causing the defect of the products based on the contribution scores, the controller to output information on a display indicative of at least one of the equipment causing the defect of the products.

Identifying at least one of the plurality of equipment causing the defect may include applying a modified association rule to the equipment based on the calculated contributions scores; calculating a defect-introducing index based on the calculated contribution scores and the modified association rule; and identifying at least one of the plurality of selected equipment causing the defect of the products based on the defect-introducing index. The modified association rule may generate rules reflecting a cumulative effect of an equipment sequence and equipment contributing to the defect.

Applying the modified association rule may include generating the rules by removing equipment having contribution scores equal to or less than a first reference value from equipment corresponding to the equipment sequence data; calculating cumulative effect values from the rules, the cumulative effect values generated by equipment of a subsequent process among equipment included in the rules; selecting rules having cumulative effect values greater than a second reference value; and calculating a representative value of parameters generated in applying the modified association rule, with respect to the selected association rules. The cumulative effect values may be a ratio of an amount of accuracy increased by a first process to an accuracy of a second process.

### BRIEF DESCRIPTION OF THE DRAWINGS

Features will become apparent to those of skill in the art by describing in detail exemplary embodiments with reference to the attached drawings in which:

FIG. 1 illustrates an embodiment of a system for determining equipment causing a product defect in a manufacturing process;

FIG. 2 illustrates an embodiment of a manufacturing system;

FIG. 3 illustrates an embodiment of a method for determining equipment causing a product defect;

FIGS. 4A to 4C illustrate embodiments of methods for calculating an equipment contribution score;

FIG. 5 illustrates an embodiment of an application operation in FIG. 3;

FIG. 6 illustrates an example of a cumulative effect causing a product defect;

FIG. 7 illustrates another embodiment of a method for determining equipment causing a product defect in a manufacturing process;

FIG. 8 illustrates an embodiment of a semiconductor manufacturing process;

FIG. 9 illustrates an embodiment for determining equipment causing a defect in a liquid crystal display manufacturing process; and

FIG. 10 shows an example of a controller 3000 for determining defect causing equipment in a manufacturing process.

### DETAILED DESCRIPTION

Example embodiments are described more fully hereinafter with reference to the accompanying drawings; however, they may be embodied in different forms and should not be construed as limited to the embodiments set forth herein. Rather, these embodiments are provided so that this disclosure will be thorough and complete, and will fully convey exemplary implementations to those skilled in the art. In the drawings, the dimensions of layers and regions may be exaggerated for clarity of illustration. Like reference numerals refer to like elements throughout.

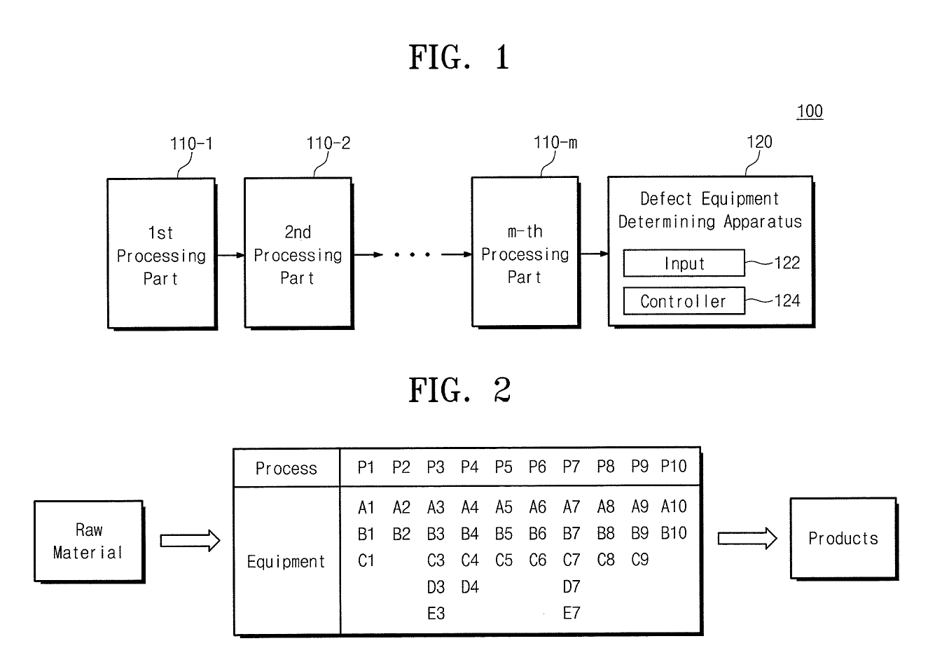

FIG. 1 illustrates an embodiment of a system 100 for determining equipment causing a product defect in a manufacturing process. The system 100 includes a plurality of processing parts 110-1 to 110-m and an apparatus 120 for determining equipment causing a defect. Hereinafter, the equipment causing a defect is referred to as defect causing equipment, and the apparatus 120 for determining the defect causing equipment is referred to as defect equipment discovering apparatus 120.

In FIG. 1, processes may be sequentially performed through a first processing part 110-1 to an m-th processing part 110-m to produce a product. If the processes are included in a semiconductor manufacturing process, the processes performed by the plurality of processing parts 110-1 to 110-m may include, for example, a wafer manufacturing process, a circuit designing process, a mask manufacturing process, and a wafer fabricating process. The wafer fabricating process may include an oxidation process, a photoresist coating process, an exposure process, a development process, an etching process, and an ion implantation process. The first processing part 110-1 may perform the oxidation process, the second processing part 110-2 may perform the photoresist coating process, and the third processing part 110-3 may perform the exposure process. The other processing parts may perform other semiconductor processes.

A plurality of equipment may be used in each of the first processing part 110-1 to the m-th processing part 110-m. An initial input material (e.g., a raw material) may pass through specific equipment respectively used in the processing parts according to a set schedule until a product is completed. Hereinafter, a trace of the specific equipment through which the raw material passes until the product is completed is referred to as equipment sequence data. A variety of sequences of the equipment may be used. In one embodiment, the equipment sequence data of various products may be different from each other.

The defect equipment determining apparatus 120 may identify suspicious equipment using the equipment sequence data and processing result data. The processing result data may include data obtained by judging whether the product, which has normally passed through the equipment according to the equipment sequence, is normal or bad. In the present embodiment, the defect equipment discovering apparatus 120 includes an input part 122 and a controller 124.

The input part 122 may receive the equipment sequence data from the processing parts 110-1 to 110-m. The input part 122 may also receive the processing result data from, for example, an additional tester that judges whether the product is normal or bad. The received equipment sequence data and processing result data may be used to discover the defect causing equipment and to search an optimized equipment sequence capable of increasing yield.

In one embodiment, the defect equipment discovering apparatus 120 may calculate a contribution score of each piece of equipment that may contribute to the product defect. In addition, the defect equipment discovering apparatus 120 may calculate a cumulative effect caused by an interrelationship, for example, between or among equipment for performing a prior process and equipment for performing a subsequent process. The defect equipment discovering apparatus 120 may effectively determine suspicious equipment, which is responsible for causing the product defect, based on the calculated contribution score of each equipment and the calculated cumulative effect. As a result, an optimized equipment sequence for increasing the yield of the manufacturing process may be identified.

FIG. 2 illustrates an embodiment of a system for manufacturing a product. This system may be referred to for purposes of explaining an embodiment of a method for determining equipment causing a product defect.

Referring to FIG. 2, raw material may be manufactured through processes P1 to P10. Equipment A1, B1, and C1 may be used for process P1, and equipment A2 and B2 may be used for process P2. Likewise, these or other equipment may be used for processes P3 to P10. The raw material may pass through predetermined equipment of processes P1 to P10 according to a set schedule, so as to be formed into the product. For example, the equipment sequence for manufacturing the product may be selected according to the set schedule, such as A1→B2→E3→ . . . →B8→A9→B10.

The manufacturing system of FIG. 2 will be described as an example. However, the number of process and/or number of the equipment to be used for each process may be different in other embodiments.

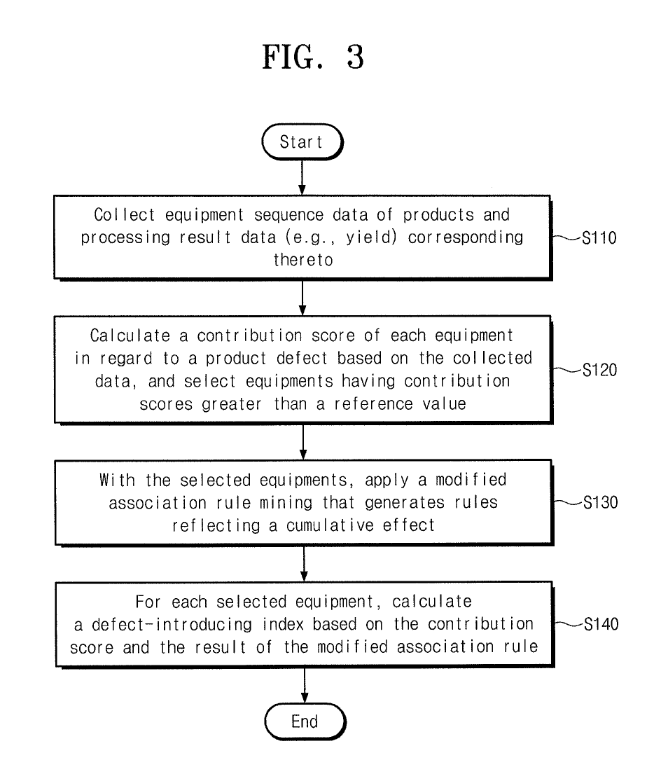

FIG. 3 illustrates an embodiment of a method for determining equipment causing a product defect. The method includes collecting equipment sequence data and the processing result data, in operation S110. As previously described, the equipment sequence data may correspond to the trace of the specific equipment through which the raw material passes until the product is completed. In one embodiment, the equipment sequence data includes binary data of 1s and/or 0s, which are assigned, for example, depending on whether or not the raw material/product has passed through the equipment. For example, if the product has passed through equipment E3 in a third process P3 of FIG. 2, the equipment sequence data of the third process P3 may be “00001”.

The processing result data may correspond to data obtained by judging whether the product, which has normally passed through the equipment according to the equipment sequence, is normal or bad. For example, the processing result data may include binary data of 1s and/or 0s depending on whether the product is normal or bad. In another embodiment, the processing result data may be represented as a continuous variable depending on the degree of normality. The processing result data may be collected from an additional tester that judges whether the product in normal or not.

In operation S120, a contribution score for each equipment in regard to the product defect may be calculated based on the collected equipment sequence data and the processing result data. In addition, equipment having contribution scores greater than a reference value may be selected in the operation S120.

At least one of various mathematical algorithms may be used to calculate the contribution score of each equipment in regard to the product defect. The contribution score of each equipment may be calculated, for example, using a method for synthetically analyzing a relationship between or among various variables. Examples include a multi-variate regression analysis method or a variable selection method. The contribution score of each equipment may be calculated, for example, using a partial least square regression-important in the projection (PLSR-VIP) method, a minimum-redundancy-maximum-relevance (mRMR) variable selection method, or a support vector machine recursive feature elimination (SVM-RFE) method.

In one embodiment, the contribution score of each equipment in regard to the product defect may be calculated using the PLSR-VIP method. This is because the PLSR-VIP method reduces the amount of data that will be analyzed. For example, the number of cases of equipment sequences through which the raw material passes may be 97200 (3×2×5×4×3×3×5×3×3×2=97200). It may be very difficult to analyze the great amount of the data in real time and to discover the equipment influencing the product defect. Thus, some equipment having low contribution scores may be removed in regard to the product defect based on the data.

The PLSR of the PLSR-VIP method will be described as examples. If a plurality of independent variables (e.g., X1 and X2) and one dependent variable (e.g., Y) satisfy a linear equation (e.g., Y=a×X1+b×X2+c), a new linear equation between the dependent variable (i.e., Y) and new independent variables (i.e., latent independent variables t1 and t2) is set up and a latent independent variable (e.g., t2) having a low contribution score to the dependent variable (i.e., Y) is removed.

The VIP of the PLSR-VIP method calculates the influence of the original independent variables (i.e., X1 and X2) on the dependent variable (i.e., Y) from a newly calculated linear equation (e.g., Y=a′×t1+b′) with regard to the latent independent variable. Because the PLSR-VIP method is used, the number of analyzed variables (or the amount of analyzed data) may be reduced and the contribution scores of the equipment involved in the product defect may be effectively calculated.

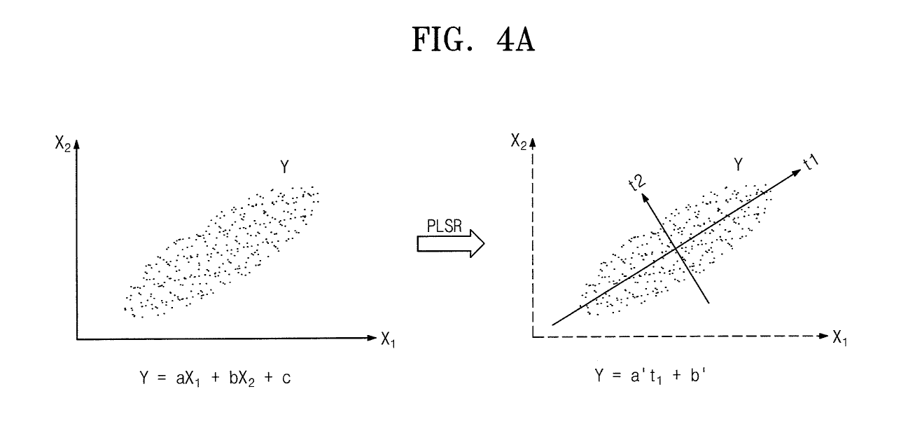

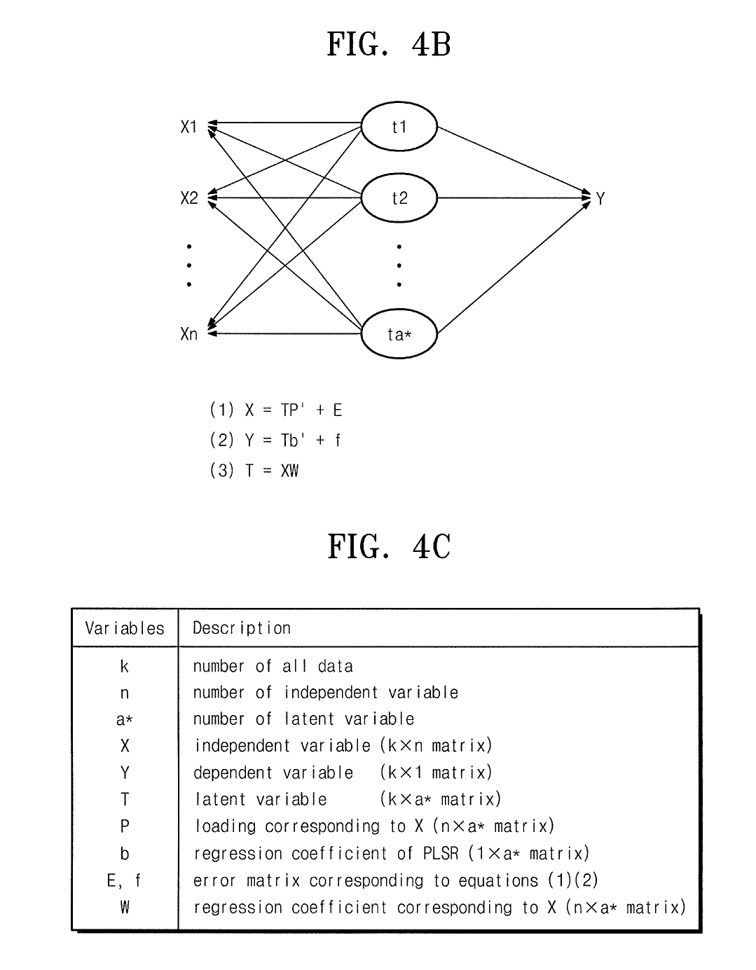

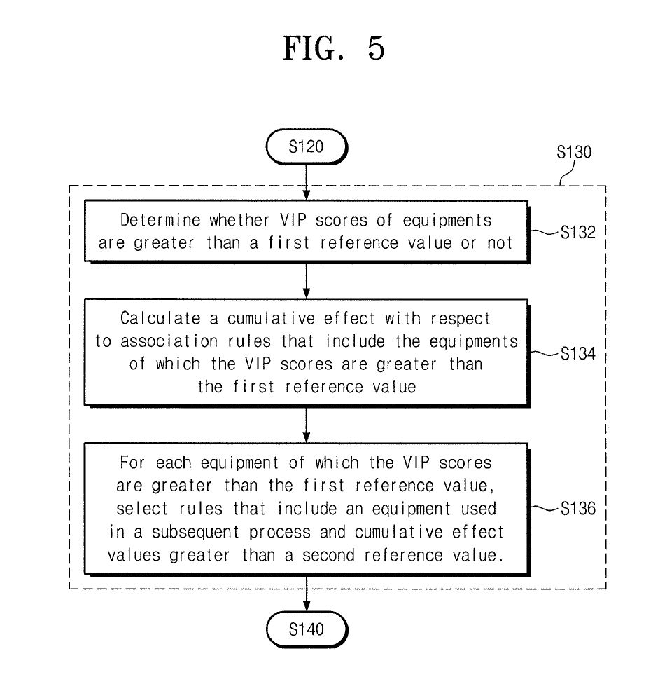

In other embodiments, a method different from a PLSR-VIP method may be used. For example, at least one of various methods (e.g., the multi-variate regression analysis method and the variable selection method) may be used to calculate the contribution score of the each equipment. Examples of methods for calculating the contribution score of each equipment in regard to the product defect will be described in detail with reference to FIGS. 4A to 4C.

In operation S130, an association rule, which is modified reflecting the cumulative effect contributed to the product defect, may be applied to equipment selected based on the calculated contribution scores. For example, a modified association rule mining that generates association rules reflecting the cumulative effect may be applied to equipment selected based on the calculated contribution scores.

If an original equipment sequence is A1→B2→E3→ . . . →B8→A9→B10 in FIG. 2, the original equipment sequence may be simplified into an equipment sequence of E3→A9 because equipment having small contribution scores with regard to the product defect are removed in operation S120. For example, equipment E3 of the third process P3 and equipment A9 of a ninth process P9 have large contribution scores with regard to the product defect.

However, because an interrelationship between equipment exists in a process of manufacturing fine patterns (e.g., a semiconductor manufacturing process), a former process and a subsequent process may complexly cause the product defect. Thus, confirmation of the cumulative effect showing a contribution degree of the former process contributed to the product defect caused by the subsequent process, as well as calculation of the contribution score of each equipment in regard to the product defect, may be obtained. If suspicious equipment causing the product defect is determined based on the cumulative effect, the defect causing equipment may be more effectively determined and the optimized equipment sequence increasing yield may be effectively searched.

As described above, a modified association rule reflecting the cumulative effect may be applied to selected equipment. Because the modified association rule is applied, it is possible to obtain a parameter for calculating a defect-introducing index that is contributed to the product defect.

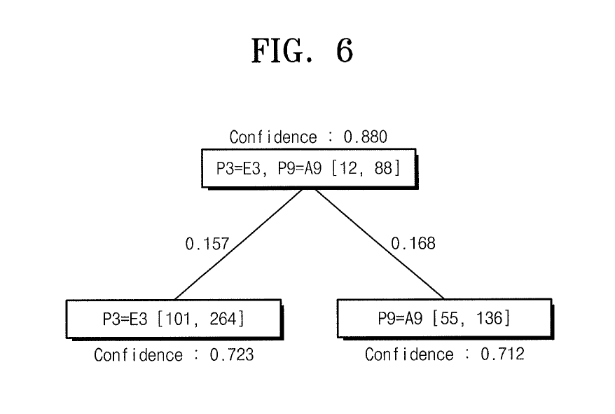

An example of a method for calculating the contribution score of the former process to the defect of the subsequent process using the cumulative effect, and a method for obtaining the parameter using the association rule, will be described in detail with reference to FIGS. 5 and 6.

In operation S140, the defect-introducing index for each selected equipment may be calculated based on the contribution score of each selected equipment and the result of the modified association rule. The defect-introducing index is calculated using a VIP score calculated in operation S120 and the parameters calculated in operation S130. In one embodiment, the defect-introducing index may be calculated based on the contribution score of the former process to the defect caused the subsequent process, as well as the contribution score of each equipment to the defect, and output, e.g., displayed. Thus, it is possible to increase efficiency and reliability of the method for discovering the defect causing equipment, such that the defect causing equipment may be repaired or replaced. In addition, it is possible to search for and determine the optimized equipment sequence for increasing yield of the manufacturing process. The results of the search may be used to reorder the equipment sequence.

FIGS. 4A to 4C illustrate embodiments of methods for calculating a contribution score of each equipment contributed to a product defect. FIG. 4A illustrates a method for obtaining a new linear equation for a reduced number of independent variables (e.g., latent independent variables) from an original linear equation.

Before the PLSR is applied, the dependent variable Y may be represented by a linear equation (e.g., Y=a×X1+b×X2+c) of independent variables X1 and X2. The independent variables X1 and X2 may correspond to equipment in the manufacturing process, and the dependent variable Y may correspond to equipment sequence data.

In the system of FIG. 2, the number of the independent variables may be 33 corresponding to the number of all equipment, e.g., independent variables X1 to X33. In this case, it is difficult to calculate the contribution score of each of the large number of independent variables with respect to a dependent variable (e.g., yield). Thus, the number of the independent variables may be reduced by a certain method.

After the PLSR is applied, the number of the independent variables may be reduced. s illustrated in a right diagram of FIG. 4A, a new orthogonal coordinate system of new independent variables t1 and t2 may be generated, instead of an orthogonal coordinate system of the original independent variables X1 and X2. In this case, the dependent variable Y may be represented by the new linear equation of the new independent variables t1 and t2, e.g., the latent variables. However, in a data distribution, the spread of data in a direction t2 is significantly smaller than the spread of data in direction t1. Thus, the contribution score of the latent variable t2 to the dependent variable Y is low. Thus, the latent variable t2 may be disregard and the dependent variable Y may be represented by the linear equation (Y=a′×t1+b′) of the latent variable t1.

FIG. 4B illustrates an example of relationships of the equipment sequence data, the processing result data, and the latent variable. FIG. 4C illustrates an example of a table explaining variables when the PLSR is applied. When applied to a semiconductor manufacturing process, the number of all data “k” may correspond, for example, to the number of all wafers. The independent variables X may correspond to all equipment, and the number of the independent variables “n” may correspond to the number of all equipment. The dependent variable Y may correspond to wafer yield.

In one embodiment, the latent variable T satisfying Equations 1 to 3 may be obtained to exclude equipment having low contribution scores to the product defect. The latent variable T is a result including information of the equipment sequence data and the processing result data.

X=TP′=E (1)

Y=Tb′+f (2)

T=XW (3)

Variable matrixes calculated by the PLSR may be used to perform the calculation of Equation 4.

$${VIP}_{j} = \sqrt{\frac{k {\sum }_{a = 1}^{{a}^{*}} [ ( {b}_{a}^{2} {t}_{a}^{′} {t}_{a} ) {( \frac{{W}_{aj}}{‖ {W}_{a} ‖} )}^{2} ]}{{\sum }_{a = 1}^{{a}^{*}} ( {b}_{a}^{2} {t}_{a}^{′} {t}_{a} )}} \qquad ( 4 )$$

Equation 4 may calculate the contribution scores of the original independent variables (e.g., X1, X2, etc.) with respect to the dependent variable. Because the Equations 1 to 3 confirm only the contribution scores of the latent variables (e.g., t1, t2, etc.) to the dependent variable Y, Equation 4 may be used. The contribution scores of the original independent variables may be calculated from a reduced number of latent variables, so the number of calculating operations may be markedly reduced.

In Equation 4,“VIPj” may mean a contribution score of a j-th independent variable to the dependent variable. When this is applied to the manufacturing process, “j” may refer to corresponding equipment through which the product passes and the dependent variable may refer to yield. Thus, the VIPj obtained from Equation 4 may be analyzed as a contribution score of the corresponding equipment j influencing a processing result.

In the present embodiment, the PLSR-VIP method is used to calculate the contribution scores influencing the product defect. In another embodiment, the contribution scores may be calculated using another method for synthetically analyzing a relationship between or among various variables, such as but not limited to a multi-variate regression analysis method or a variable selection method. For example, the contribution scores may be calculated using a minimum-redundancy-maximum-relevance (mRMR) variable selection method or a support vector machine recursive feature elimination (SVM-RFE) method.

FIG. 5 illustrates an embodiment of operation S130 in FIG. 3. Referring to FIG. 5, whether or not VIP scores are greater than a first reference value may be determined in operation S132. For example, in operation S132, association rules may be generated in regard to equipment having VIP scores, calculated by Equation 4, which are greater than a first reference value. For example, equipment having VIP scores equal to or less than the first reference value may be removed from all equipment corresponding to specific equipment sequence data, to generate the association rules. This is because only equipment having high contribution scores to the product defect may be selected to the amount of data and to increase search efficiency.

In one embodiment, the first reference value may be randomly set or modified depending on the VIP scores. The association rule may be a method for finding a remarkable rule from a large amount of data. The association rule may be an algorithm that generates a remarkable rule from a defect equipment group (e.g., single equipment or a relationship between or among equipment, for example, of former and subsequent processes), and an accuracy of each rule is calculated. For example, in FIG. 6, a rule P3 =E3, P9=A9 [12, 88] means that 88 wafers are bad among 100 wafers when the wafers are processed in equipment E3 and A9, and the accuracy of this rule is 88%.

Parameters such as support values and confidence values may be used when the association rule is applied. A support value may refer to an occurrence rate of specific rules among all data. When applied to one or more embodiment described herein, the support value may correspond to a ratio of the number of wafers passing through corresponding equipment to the number of all wafers. The confidence value may refer to a ratio of the number of bad wafers to the number of products passing through corresponding equipment. In other words, the confidence value may correspond to the accuracy of the rule. The support value and the confidence value of each rule are calculated.

In operation S134, the cumulative effect may be calculated. For example, the cumulative effect may be calculated with respect to rules that include equipment having VIP scores are greater than the first reference value. The cumulative effect may correspond to a difference between the accuracy of the rule of input material passing through only a former process and the accuracy of the rule of input material passing through both the former process and a subsequent process. The cumulative effect may be based on Equation 5. The cumulative effect will be described in more detail with reference to FIG. 6.

$$Cumulative effect ( \% ) = \frac{The amount of accuracy increased by subsequent process}{Accracy of former process} \times 100 ( \% ) \qquad ( 5 )$$

FIG. 6 illustrates explains an embodiment for determining cumulative effect caused by an interrelationship between or among equipment of a former process and an equipment of a subsequent process, for influencing a product defect.

Referring to FIG. 6, a rule P3=E3 [101, 264] shows the number (i.e., 101) of normal products and the number (i.e., 264) of bad products when each input material passes through equipment E3 during the third process P3. The rule P3=E3, P9=A9 [12, 88] shows the number of products and the number of bad products when each input material passes through equipment E3 of the third process P3 and equipment A9 of the ninth process P9. According to the association rule P3=E3, P9=A9 [12, 88], the number of normal products is 12 and the number of bad products is 88.

In FIG. 6, the association rule P3=E3 [101, 264] corresponds to the former process, so the amount of accuracy increased by the subsequent process is 0.157 that corresponds to a difference between the confidences. The cumulative effect of the equipment A9 of the subsequent process with respect to the former process is 21.7% by Equation 5 (0.157/0.723×100=21.7%).

Referring again to FIG. 5, a representative value of parameters generated when the modified association rule is applied may be calculated in operation S136. For example, the following course may be performed for each equipment having VIP scores greater than the first reference value. Specific rules may be selected. The selected rules include equipment used in the subsequent process and cumulative effect values greater than a second reference value.

The representative values of the parameters may be calculated with respect to the selected association rules. For example, the support values of the rules having the cumulative effect values greater than the second reference value may be selected from among the support values calculated in operation S132, and the representative values of the selected support values may be calculated. For example, the representative value may be one of, but not limited to, an arithmetic mean value, a robust mean value, a trimmed mean value, a weighted mean value, a geometric mean value, a harmonic mean value, or a median value. In the present embodiment, the arithmetic mean value will be described as an example of the representative value.

An arithmetic mean value (support_{avg}) of the selected support values will be calculated to explain the present embodiment. The arithmetic mean value (support_{avg}) of the selected support values may be referred to as ‘a support mean value (support_{avg})’. Likewise, the confidence values of the rules having the cumulative effect values greater than the second reference value may be selected from among the confidence values calculated in operation S132, and the representative value of the selected confidence values may be calculated. The representative value of the selected confidence values may be one of, but not limited to, an arithmetic mean value, a robust mean value, a trimmed mean value, a weighted mean value, a geometric mean value, a harmonic mean value, or a median value.

In the present embodiment, the arithmetic mean value (confidence_{avg}) will be explained as an example of the representative value of the selected confidence values. Hereinafter, the arithmetic mean value (confidence_{avg}) of the selected confidence values may be referred to as ‘a confidence mean value (confidence_{avg})’. The second reference value may be randomly set or modified depending on the calculated cumulative effect values. In the point of the association rule is applied to the rule having the cumulative effect value greater than the second reference value, it is defined as “the modified association rule.” The modified association rule is applied to use algorithm such as Apriori, Eclat, AprioriDP, or CMPNARM. The modified association rule reflecting the cumulative effect contributed to the product defect may be applied to obtain all elements required to calculate the defect-introducing index.

The defect-introducing index (or a suspicious index) may be used to determine suspicious equipment causing the product defect based on the contribution score of each equipment to the product defect and the modified association rule reflecting the cumulative effect. The defect-introducing index may be calculated with respect to each equipment based on Equation 6.

$$Suspicious Index = \frac{f ( VIP value , {support}_{avg} , {confidence}_{avg} , Bad - Wafers )}{g ( Rule - {length}_{avg} )} \qquad ( 6 )$$

In Equation 6,“f” denotes a function using at least one of the VIP score, the support mean value (support_{avg}), the confidence mean value (confidence_{avg}), or bad-wafers as an independent variable. Equation 6 represents the function using the four independent variables as an example. In Equation 6, “g” denotes a function using a rule-length mean value (Rule-length_{avg}) as an independent variable. As described above, the defect-introducing index (or the suspicious index) is represented by the functions f and g. Thus, the defect-introducing index may be calculated by various combinations of the support mean value (support_{avg}), the confidence mean value (confidence_{avg}), the bad-wafers, and the rule-length mean value (Rule-length_{avg}).

The VIP score is the contribution score of each equipment to the product defect, calculated, for example, by Equation 4. The support mean value (support_{avg}) and the confidence mean value (confidence_{avg}) are values calculated in operation S136 of FIG. 5. The rule-length mean value (Rule-length_{avg}) corresponds to a mean value of the number of equipment used to manufacture the product when the cumulative effect value is greater than the second reference value in operation S136.

For example, in the rule such as P3=E3, P9=A9 [12, 88], a length of the association rule is 2 because equipment E3 and A9 are used to manufacture the product. If an additional association rule P9=A9 [20, 200] including equipment A9 further exists, a length of the additional association rule is 1. Thus, the rule-length mean value of equipment A9 is 1.5 ((2+1)/2=1.5). The bad-wafers may be the number of bad wafers. The bad-wafers may be a weight value provided to calculate the defect-introducing index.

Equation 6 may be optionally obtained using the VIP value (e.g., contribution score of each equipment to the product defect) and the parameters generated in the modified association rule reflecting the cumulative effect. For example, various defect-introducing indexes may be obtained using the contribution score of each equipment to the product defect and the parameters generated in the modified association rule reflecting the cumulative effect.

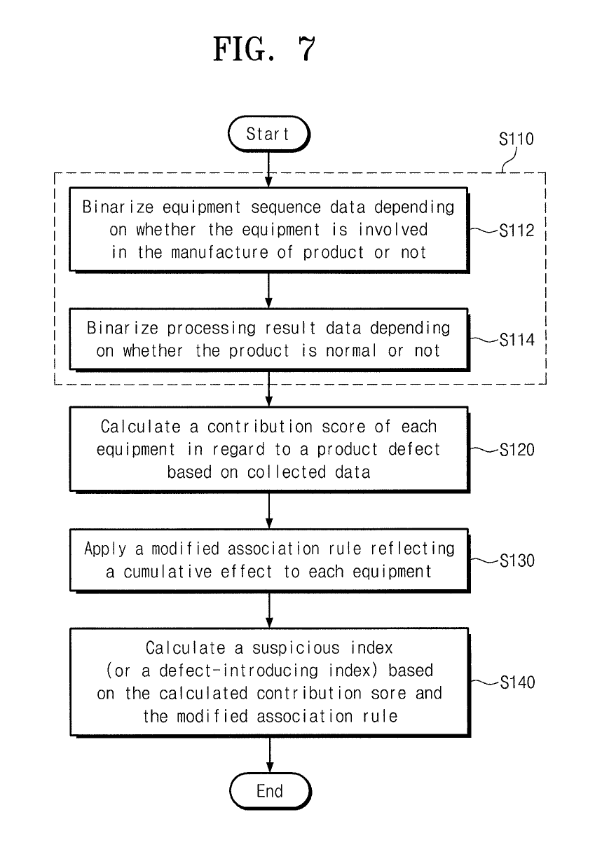

FIG. 7 illustrates another embodiment of a method for determining equipment causing a product defect. In operation S112, the equipment sequence data may be given a binary representation depending on whether each equipment is involved in the manufacture of a product or not. The equipment sequence data may be collected as binarizy data of 1s and/or 0s according to whether the product passes through specific equipment or not. For example, the equipment sequence data may be collected from each process. If the equipment sequence of the product is B8→A9→B10 in FIG. 2, the equipment sequent data may be represented as 1000100001 . . . 01010001.

In operation S114, the processing result data may be binarized depending on whether the product is normal or not. The processing result data may correspond to data obtained by finally judging whether the product, which has normally passed through the equipment according to the equipment sequence, is normal or bad. For example, the processing result data may be collected as binary data of 1s and/or 0s according to whether the product is normal or bad. For example, the processing result data may be collected from an additional tester that judges whether the product is normal or bad.

Operations S120 to S130 of FIG. 7 may be the same as described with reference to FIG. 2.

In one embodiment, the defect-introducing index may be calculated based on the contribution score of the former process to the defect caused the subsequent process, as well as the contribution score of each equipment to the defect, and output, e.g., displayed. Thus, it is possible to increase efficiency and reliability for determining defect causing equipment, such that the defect causing equipment may be repaired or replaced. In addition, it is possible to search for the optimized equipment sequence for increasing yield of the manufacturing process. The results of the search may be used to reorder the equipment sequence.

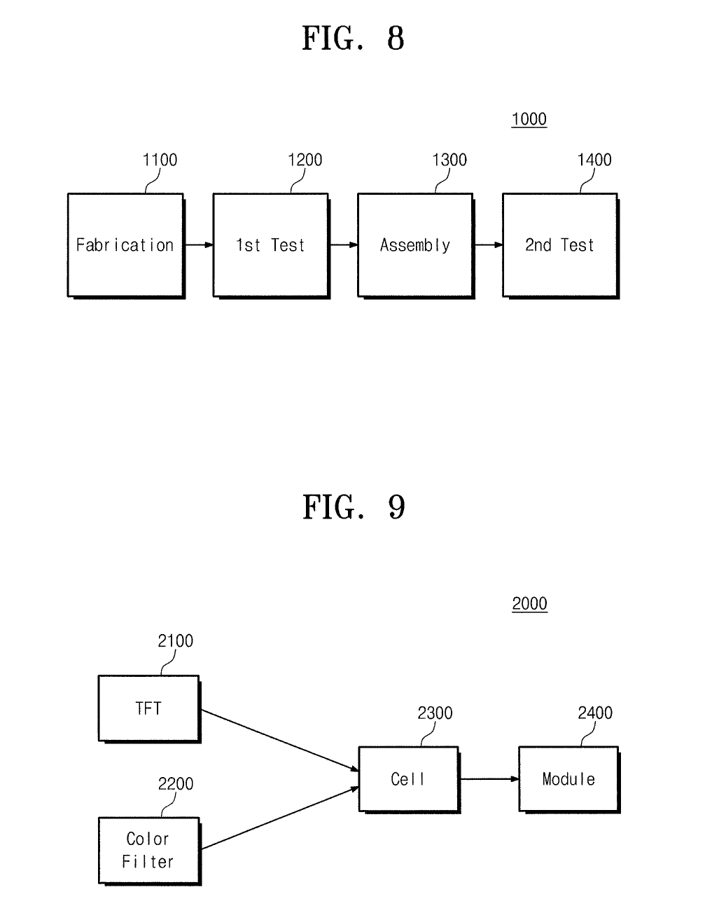

FIG. 8 illustrates an example of a semiconductor manufacturing process 1000, to which an embodiment of a method for determining equipment causing a product defect may be applied. The semiconductor manufacturing process 1000 includes a fabricating process 1100 and an assembly process 1300. If the fabricating process 110 is completed, a first test 1200 may be performed. If the assembly process 1300 is completed, a second test 1400 may be performed.

The fabricating process 1100 may include a photolithography process, an etching process, a diffusion process, a chemical vapor deposition (CVD) process, or an interconnection process. A plurality of equipment may be used for each of the processes, so the equipment sequence through which raw material passes when a wafer (e.g., a semiconductor device) is completed may vary.

The first test 1200 may test whether the wafer (e.g., the semiconductor device) manufactured by the fabricating process 1100 is normal or bad. For example, the first test 1200 may be an electrical die sorting (EDS) test. In the EDS test, an electrical characteristic test may be performed on the manufactured wafer to test whether the wafer satisfies a reference quality or not. The EDS test may include at least one of an electrical test & wafer burn in (ET test & WBI) process, a pre-laser (hot/cold) process, a laser repair & post laser process, a tape laminate & bake grinding process, or an inking process.

Processing result data may be collected. The processing result data may be data obtained by judging whether the product tested by the first test 1200 is normal or not. According to one embodiment, equipment sequence data may be collected from the fabricating process 1100, and the processing result data may be collected from the first test 1200. The collected data may be used to identify suspicious equipment causing a product defect.

In addition, one embodiment may be applied to the assembly process 1300. For example, the assembly process 1300 may be a packaging process and the second test 1400 may be a package test. The second test 1400 may include, for example, at least one of assembly out test, a direct current (DC) test & loading/burn-in (& unloading) test, a monitoring burn-in & test (MBT), a post burn test, or a final test. The second test 1400 may be performed on a package manufactured through the assembly process 1300 to judge whether the product is finally normal or not.

In one embodiment, equipment sequence data may be collected from the assembly process 1300 and processing result data may be collected from the second test 1400. The collected data may be used to identify suspicious equipment causing the product defect.

FIG. 9 illustrates an embodiment of a method for determining equipment causing a product defect during manufacturing of a liquid crystal display (LCD). The LCD manufacturing process 2000 may include a thin film transistor (TFT) process 2100, a color filter process 2200, a cell process 2300, and a module process 2400. In addition, each of the processes 2100, 2200, 2300, and 2400 may a lot of sub-processes. For example, the TFT process 2100 may include a cleaning process, a deposition process, a photoresist (PR) coating process, an exposure process, a development process, an etching process, and/or a PR strip process.

If the TFT process 2100 is completed, a test may be performed to judge whether a product (e.g., the TFT) is normal or not. In one embodiment, equipment sequence data may be collected from a plurality of sub-processes included in the TFT process 2100, and processing result data may be collected from a tester for testing whether the TFT is normal or not. The collected data may be used to identify suspicious equipment causing a product defect. Likewise, the embodiments may be applied to other processes 2200, 2300, and 2400.

In one or more of the aforementioned embodiments, it is possible to effectively determine suspicious equipment, an equipment recipe, or a reticle which causes a defect of the products, and to output the results, such that, for example, defect causing equipment may be repaired or replaced. Also, it is possible to search for the optimized equipment sequence for increasing the yield of a manufacturing process. The results of the search may be used to reorder the equipment sequence.

The methods, processes, and/or operations described herein may be performed by code or instructions to be executed by a computer, processor, controller, or other signal processing device. The computer, processor, controller, or other signal processing device may be those described herein or one in addition to the elements described herein. Because the algorithms that form the basis of the methods (or operations of the computer, processor, controller, or other signal processing device) are described in detail, the code or instructions for implementing the operations of the method embodiments may transform the computer, processor, controller, or other signal processing device into a special-purpose processor for performing the methods described herein.

Also, another embodiment may include a computer-readable medium, e.g., a non-transitory computer-readable medium, for storing the code or instructions described above. The computer-readable medium may be a volatile or non-volatile memory or other storage device, which may be removably or fixedly coupled to the computer, processor, controller, or other signal processing device which is to execute the code or instructions for performing the method embodiments described herein.

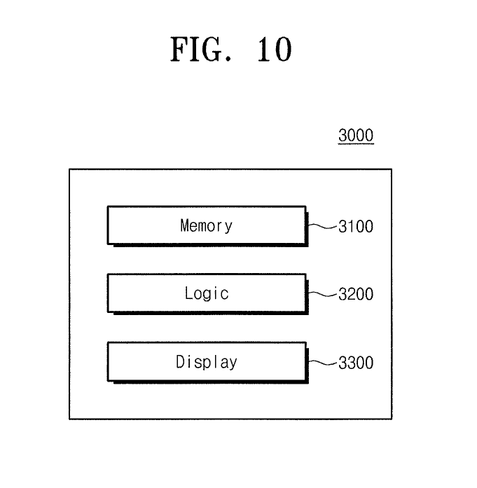

FIG. 10 shows an example of a controller 3000 for determining defect causing equipment in a manufacturing process. The controller 3000 includes a memory 3100, logic 3200, and a display 3300. The memory 3100 and logic 3200 may perform operations of the aforementioned embodiments.

For example, memory 3100 may store collecting equipment sequence data and processing result data for manufacturing a plurality of products, at least some of the products having a defect. The 3200 logic may calculate contribution scores for a plurality of equipment used to manufacture the products based on the collected data, and to identify at least one of the plurality of equipment causing the defect of the products based on the contribution scores, the controller to output information on a display indicative of at least one of the equipment causing the defect of the products. The display 2050 may display information identifying at least one of the plurality of equipment causing the defect in the products based on the defect-introducing index.

Example embodiments have been disclosed herein, and although specific terms are employed, they are used and are to be interpreted in a generic and descriptive sense only and not for purpose of limitation. In some instances, as would be apparent to one of skill in the art as of the filing of the present application, features, characteristics, and/or elements described in connection with a particular embodiment may be used singly or in combination with features, characteristics, and/or elements described in connection with other embodiments unless otherwise indicated. Accordingly, it will be understood by those of skill in the art that various changes in form and details may be made without departing from the spirit and scope of the present invention as set forth in the following claims.

What is claimed is:

1. A method for determining defect causing equipment in a manufacturing process, the method comprising:
collecting equipment sequence data and processing result data of a plurality of products;
calculating defect contribution scores for a plurality of equipment based on the collected data;
applying a modified association rule to the equipment based on the calculated contributions scores, the modified association rule to generate rules reflecting a cumulative effect of an equipment sequence and equipment contributing to a defect of at least some of the products;
calculating a defect-introducing index based on the calculated contribution scores and the modified association rule;
identifying at least one of the plurality of equipment causing the defect of the products based on the defect-introducing index; and
outputting information on a display indicative of at least one of the equipment causing the defect of the products.

2. The method as claimed in claim 1, wherein collecting the equipment sequence data and the processing result data of the products includes:
generating a binary representation of the equipment sequence data depending on whether or not corresponding ones of the plurality of equipment are involved in manufacture of the products; and
generating a binary representation of the processing result data depending on whether or not the products are normal.

3. The method as claimed in claim 2, wherein calculating the contribution score is performed based on a multi-variate regression analysis method or a variable selection method.

4. The method as claimed in claim 3, wherein the multi-variate regression analysis method or the variable selection method is one of a partial least square regression-important in the projection (PLSR-VIP) method, a minimum-redundancy-maximum-relevance (mRMR) variable selection method, or a support vector machine recursive feature elimination (SVM-RFE) method.

5. The method as claimed in claim 3, wherein applying the modified association rule includes:
generating the rules by removing equipment having contribution scores equal to or less than a first reference value from equipment corresponding to the equipment sequence data;
calculating cumulative effect values from the rules, the cumulative effect values generated by equipment of a subsequent process among equipment included in the rules;
selecting rules having cumulative effect values greater than a second reference value; and
calculating a representative value of parameters generated in applying the modified association rule, with respect to the selected association rules.

6. The method as claimed in claim 5, wherein the cumulative effect value is a ratio of an amount of accuracy increased by the subsequent process to an accuracy of a former process.

7. The method as claimed in claim 5, wherein applying the modified association rule is performed based on Apriori algorithm, Eclat algorithm, AprioriDP algorithm, or CMPNARM algorithm.

8. The method as claimed in claim 5, wherein the defect-introducing index includes a first function using at least one of the contribution score, the representative value, or a number of defect products as an independent variable.

9. The method as claimed in claim 8, wherein the representative value is one of an arithmetic mean value, a robust mean value, a trimmed mean value, a weighted mean value, a geometric mean value, a harmonic mean value, or a median value.

10. The method as claimed in claim 9, wherein:
the defect-introducing index includes a second function, and an independent variable of the second function is a mean value of the number of equipment corresponding to the association rules having cumulative effect values greater than the second reference value.

11. An apparatus for determining defect causing equipment, the apparatus comprising:
an input to collect equipment sequence data and processing result data of a plurality of products; and
a controller to calculate contribution scores for a plurality of equipment based on the collected data, to apply a modified association rule to the equipment based on the calculated contributions scores, the modified association rule generating rules reflecting a cumulative effect of an equipment sequence and equipment contributing to a defect in at least some of the products, and to calculate a defect-introducing index based on the calculated contribution scores and the modified association rule, the defect-introducing index corresponding to at least one of the plurality of equipment causing the defect, the controller to output information on a display indicative of at least one of the equipment causing the defect of the products.

12. The apparatus as claimed in claim 11, wherein the controller is to:
generate a binary representation of the equipment sequence data depending on whether the equipment are involved in the manufacture of the products or not, and
generate a binary representation of the processing result data depending on whether or not the products are normal.

13. The apparatus as claimed in claim 12, wherein the controller is to calculate the contribution scores by one of a partial least square regression-important in the projection (PLSR-VIP) method, a minimum-redundancy-maximum-relevance (mRMR) variable selection method, or a support vector machine recursive feature elimination (SVM-RFE) method.

14. The apparatus as claimed in claim 13, wherein the cumulative effect is a ratio of an amount of accuracy increased by a subsequent process to an accuracy of a former process.

15. The apparatus as claimed in claim 14, wherein the controller is to:
remove equipment having contribution scores equal to or less than a first reference value from equipment corresponding to the equipment sequence data to generate the rules,
calculate cumulative effect values from the rules, the cumulative effect values are generated by an equipment of the subsequent process among equipment included in the association rules,
select rules of which the cumulative effect values are greater than a second reference value, and
calculate a representative value of parameters generated in applying the modified association rule, with respect to the selected rules.

16. An apparatus, comprising:
a memory to store collecting equipment sequence data and processing result data for manufacturing a plurality of products, at least some of the products having a defect; and
a controller to calculate contribution scores for a plurality of equipment used to manufacture the products based on the collected data, and to identify at least one of the plurality of equipment causing the defect of the products based on the contribution scores, the controller to output information on a display indicative of at least one of the equipment causing the defect of the products.

17. The apparatus as claimed in claim 16, identifying at least one of the plurality of equipment causing the defect includes:
applying a modified association rule to the equipment based on the calculated contributions scores;
calculating a defect-introducing index based on the calculated contribution scores and the modified association rule; and
identifying at least one of the plurality of selected equipment causing the defect of the products based on the defect-introducing index.

18. The apparatus as claimed in claim 17, wherein the modified association rule is to generate rules reflecting a cumulative effect of an equipment sequence and equipment contributing to the defect.

19. The apparatus as claimed in claim 18, wherein applying the modified association rule includes:
generating the rules by removing equipment having contribution scores equal to or less than a first reference value from equipment corresponding to the equipment sequence data;
calculating cumulative effect values from the rules, the cumulative effect values generated by equipment of a subsequent process among equipment included in the rules;
selecting rules having cumulative effect values greater than a second reference value; and
calculating a representative value of parameters generated in applying the modified association rule, with respect to the selected association rules.

20. The apparatus as claimed in claim 19, wherein each of the cumulative effect values is a ratio of an amount of accuracy increased by a first process to an accuracy of a second process.
